(19) United States
(12) Patent Application Publication
(10) Pub. No.: US 2024/0286437 A1
(43) Pub. Date: Aug. 29, 2024

(54) POLYESTER CARCASS REINFORCEMENT

(71) Applicant: KORDSA TEKNIK TEKSTIL A.S., Kocaeli (TR)

(72) Inventors: Bahadir KAYA, KOCAELI (TR); Yusuf Alper GUL, KOCAELI (TR); Mehmet Sadettin FIDAN, KOCAELI (TR); Caner IHTIYAR, KOCAELI (TR); Erhan KOP, KOCAELI (TR)

(73) Assignee: KORDSA TEKNIK TEKSTIL A.S., Kocaeli (TR)

(21) Appl. No.: 18/573,464

(22) PCT Filed: Jun. 7, 2022
(86) PCT No.: PCT/TR2022/050542

§ 371 Date: Dec. 22, 2023

(30) Foreign Application Priority Data
Jun. 22, 2021 (TR) 2021/010189

(51) Int. Cl. B60C 9/00; D02G 3/02; D02G 3/48

(52) U.S. Cl. CPC B60C 9/0042; D02G 3/02; D02G 3/48; B60C 2009/0078; D10B 2331/04; D10B 2401/063; D10B 2505/022

(57) ABSTRACT

A process for manufacturing a polyester carcass reinforcement has high tenacity improved tensile properties and high Modulus Enhancement Potential (MEP).

### CROSS REFERENCE TO THE RELATED APPLICATIONS

This application is the national phase entry of International Application No. PCT/TR2022/050542, filed on Jun. 7, 2022, which is based upon and claims priority to Turkish Patent Application No. 2021/010189, filed on Jun. 22, 2021, the entire contents of which are incorporated herein by reference.

### TECHNICAL FIELD

The present invention relates to a process for manufacturing a polyester carcass reinforcement which has high tenacity improved tensile properties and high Modulus Enhancement Potential (MEP).

### BACKGROUND

The most common tires like passenger cars and light commercial vehicles are in the trend of change. The main reason is environmental concerns and government initiatives on emission, fuel economy and noise. Therefore, the regulations demanding higher fuel economy are possibly the most immediate and important driver of change. As a raw material of tire, polyester yarns should be stronger to help reducing weight of it without losing dimensional stability.

The carcass is one of the most important parts of a radial tire, transferring all forces from the road surface to the rim, interacting with the belt package and providing flexible sidewalls. As the carcass greatly influences handling, comfort and safety, its reinforcement plays an essential role with respect to the quality of the tire and thus to its performance and durability. The tire manufacturer intends to reduce reinforcement material in tire weight while using lower denier yarns, higher tenacity and better MEP (Modulus Enhancement Potential) materials. MEP (Modulus Enhancement Potential) is stress increase at 5% elongation after being heat-set at 250° C. under 1.2 g/dtex stress for 30 secs under static conditions in Testrite apparatus (%). Balanced twisted reference greige test cord has twist multiplier between 22 and 23.

United States patent document no. U.S. Pat. No. 6,887,414 B2 discloses the high tenacity polyethylene terephthalate filaments which are useful in industrial applications, such as a tire cord for reinforcing rubber, a seat belt, a V-belt, and a hose. According to the document, efforts have been made to improve physical properties of a high tenacity industrial yarn, in particular, a toughness of a treated cord and a dimensional stability, useful as a fiber reinforcement in a rubber tire. A method for producing high strength and low shrinkage polyester fibers with a uniform fineness and physical properties are stated in this patent.

The United States patent application with the publication number of U.S. Pat. No. 4,827,999 A relates to a polyester fiber having excellent thermal dimensional stability, chemical stability, as well as high tenacity; and to a process for the production thereof. In spite of recent significant increases in the cost of the starting materials of organic fibers, for example nylon 6, the cost of the starting materials of polyesters (particularly of polyethylene terephthalate), has increased less and it is expected that this stable cost of polyesters will be maintained in future. This fact may promote enlarged demand for polyester high tenacity yarns. A polyester fibre having excellent thermal dimensional stability and chemical stability as well as high tenacity, which is a drawn yarn produced by melt-spinning a polyester comprising predominantly polyethylene terephthalate, solidifying the spun yarn and then drawing the yarn. The polyester has specified properties such as intrinsic viscosity, diethylene glycol content, and carboxyl group content. The yarn has specified properties such as average birefringence, yarn tenacity and difference of average birefringence between surface and center of monofilament, and further low dry heat shrink and work loss when heat-treated. The spinning and drawing are conducted under specified conditions. The resultant polyester fiber is useful as a reinforcement for rubber goods, specifically as a tire cord.

The European patent document no EP0080906 B1 an application known in the state of the art, discloses use of a polyester tire cord fiber which has specified properties such as intrinsic viscosity, diethylene glycol content, and carboxyl group content, and the yarn has specified properties such as average birefringence, yarn tenacity and difference of average birefringence between surface and center of monofilament, and further low dry heat shrink and work loss when heat-treated.

The United States patent document no U.S. Pat. No. 6,828,021 B2 describes polyester multifilament yarn with high modulus and low shrinkage particularly useful for the textile reinforcement of tires. This invention relates to polyester multifilament yarn with high modulus and low shrinkage particularly useful for the textile reinforcement of tires. The yarn of the invention provides high tenacity while maintaining or increasing dimensional stability with amorphous orientation function of less than about 0.75. The described polyester fiber of this invention is produced with drawing under heated conditions has higher crystalline and amorphous orientation, in other words higher birefringence than that of conventional tire grade PET fibers.

### SUMMARY

An objective of the present invention is to provide a polyester carcass ply and production method. High-tenacity polyester tire cord of the invention improves the load capacity of tire and decreases the number reinforcement layer which makes the tire lighter and decreases the rubber content of the tire.

### DETAILED DESCRIPTION OF THE EMBODIMENTS

“A Polyester Carcass Reinforcement” developed to fulfill the objectives of the present invention is clarified such that there is no limiting effect for the sake of better understanding.

The present invention relates to a carcass reinforcement comprising:
A drawn polyethylene terephthalate yarn comprising at least 90% PET by mole,
Said yarn has minimum 8.8 g/d tenacity and 2.8 g/d 5% SASE,
The greige cord, obtained by that yarn, has at least 110% modulus enhancement potential after being heat-set,
The dipped and heat-set cord of the said yarn has maximum 0.20 g/dtex shrinkforce at 180° C. under 0.05 g/dtex pretension in 2 mins.

The present invention relates to a process for manufacturing a polyester tire cord reinforcement which has high tenacity tensile properties.

For the production of high tenacity fibers, high purity chips (90 mol % or more PET chips) are subjected to a solid phase polymerization to obtain chips which has an intrinsic viscosity (IV) of 0.96 to 1.2. In the next step, these chips reach to extruder having temperature controllable zones which have set values between 230 and 320° C.

The next step is melt-zone, comprise of manifold and spin-pack, which is kept under temperature control by a secondary heating medium with a temperature between 260 to 330° C. Properly controlled melted polymer is pumped by gear pumps through the spinneret with certain number of holes depending on product type. After generating filaments by using spinneret, the quench zone starts. The starting part of the quench zone with certain length is kept heated with electrical heaters between 180 and 400° C. With the help of this higher temperature quench zone, the spun yarn finds residence area for slow cooling and avoids rapid quenching.

After heated-quench zone, the spun yarn enters into a quenching area that cool down the fibers with forced air supply.

Spun filament yarn delivered is firstly wrapped to feed roll. The drawing of yarn occurs in two different sections, and the draw ratio of first and second zones are 1.1 to 3.0, and 1.4 to 5.0 respectively. Each of the roll-sets, except first-feed roll, are heated to specific temperature.

As a next step, the drawn filament yarn coming from the last drawing roll is feed to the relaxing section with relax percentage of 0% to 20% on roll set with certain temperature control. Finally, the drawn yarn winded at a speed of 3500 to 6500 m/min.

Control samples A and B were compared with the invention (C) in Table 1. According to this, improved sample has higher tenacity and higher MEP (Modulus Enhancement Potential) parameter with same cord construction which has 1670 dtex, 2 plies, 390*390 TPM (twist number per meter) and heat treated at 250° C. under 1.2 g/dtex stress for 30 secs under static conditions in Testrite apparatus (%). The cords that heat set at 250° C. under 1.2 g/dtex stress were freely waited in the laboratory conditions without any tension and then measurements in the Table 1 were taken via Instron testing apparatus.

TABLE 1
MEP Comparison of Control A & B vs Invention (C)

| PET cord, 1670/2, | 5% LASE Greige | 5% LASE | |
|---|---|---|---|
| 390/390tpm | (kg) | Heat-set (kg) | MEP |
| Control A | 5.91 | 11.53 | 95% |
| Control B | 6.13 | 11.97 | 95% |
| Invention (C) | 5.83 | 12.71 | 118% |

The definitions of the parameters belonging to the samples are given below:
5% SASE: Stress at 5% elongation (g/dtex)
Twist Multiplier (T.M.): Twist (tpm)×(√total dtex)/1000
MEP (Modulus Enhancement Potential): Stress increase at 5% elongation after being heat-set at 250° C. under 1.2 g/dtex stress for 30 secs under static conditions in Testrite apparatus (%). Instron testing after 1 hour relaxation at 20-25° C. with free ends. Balanced twisted reference greige test cord has twist multiplier between 22 and 23.

The following technical results have been found in line with the parameters of the polyester tire cord reinforcement obtained within the scope of the invention.
Tenacity higher than 8.8 g/d enables to use thinner reinforcements in tire leading to weight and rolling resistance reduction.
The 5% SASE higher than 2.8 g/d help to obtain high modulus tire cord reinforcement after being dipped and heat-set in hot stretching process.
The MEP value higher than 110% provides sufficient resist to tire growth under high speed driving conditions and improves high speed durability of the tire.
The cord shrinkforce less than 0.20 g/dtex provides sufficient uniformity after curing process at splice zone of the carcass layer and reduces sidewall indentation (SWI).
The 5% SASE of the said dipped and heat-set cord is between 2.0 g/dtex and 4.0 g/dtex and because provides sufficient dimensional stability with enough fatigue resistance, it is preferably 2.5 g/dtex and 3.5 g/dtex.
The useful linear density range of the PET yarn is between 300 and 3500 dtex. Lower than 300 dtex yarns are more expensive and the higher than 3500 dtex might not have sufficient uniformity.
The cord twist multiplier between 15 and 30 provides sufficient compression fatigue resistance of the carcass under dynamic conditions.

What is claimed is:

1. A carcass reinforcement, comprising:
a drawn polyethylene terephthalate yarn comprising at least 90% PET by mole,
wherein the drawn polyethylene terephthalate yarn has minimum 8.8 g/d tenacity and 2.8 g/d 5% SASE,
a greige cord, obtained by the drawn polyethylene terephthalate yarn, has at least 110% modulus enhancement potential after being heat-set, and
a dipped and heat-set cord of the drawn polyethylene terephthalate yarn has maximum 0.20 g/dtex shrinkforce at 180° C. under 0.05 g/dtex pretension in 2 mins.

2. The carcass reinforcement according to claim 1, wherein 5% SASE of the dipped and heat-set cord is between 2.0 g/dtex and 4.0 g/dtex.

3. The carcass reinforcement according to claim 2, wherein 5% SASE of the dipped and heat-set cord is between 2.5 g/dtex and 3.5 g/dtex.

4. The carcass reinforcement according to claim 1, wherein a linear density of the drawn polyethylene terephthalate yarn in cord plies is minimum 300 dtex and maximum 3500 dtex.

5. The carcass reinforcement according to claim 1, wherein twist multiplier of the dipped and heat-set cord is between 15 and 30.

6. The carcass reinforcement according to claim 1, wherein the dipped and heat-set polyethylene terephthalete cord is used as carcass ply in pneumatic radial tires as dipped and heat-set cord.

7. The carcass reinforcement according to claim 2, wherein a linear density of the drawn polyethylene terephthalate yarn in cord plies is minimum 300 dtex and maximum 3500 dtex.

8. The carcass reinforcement according to claim 3, wherein a linear density of the drawn polyethylene terephthalate yarn in cord plies is minimum 300 dtex and maximum 3500 dtex.

9. The carcass reinforcement according to claim 2, wherein twist multiplier of the dipped and heat-set cord is between 15 and 30.

10. The carcass reinforcement according to claim 3, wherein twist multiplier of the dipped and heat-set cord is between 15 and 30.

11. The carcass reinforcement according to claim 4, wherein twist multiplier of the dipped and heat-set cord is between 15 and 30.

12. The carcass reinforcement according to claim 2, wherein the dipped and heat-set polyethylene terephthalete cord is used as carcass ply in pneumatic radial tires as dipped and heat-set cord.

13. The carcass reinforcement according to claim 3, wherein the dipped and heat-set polyethylene terephthalete cord is used as carcass ply in pneumatic radial tires as dipped and heat-set cord.

14. The carcass reinforcement according to claim 4, wherein the dipped and heat-set polyethylene terephthalete cord is used as carcass ply in pneumatic radial tires as dipped and heat-set cord.

15. The carcass reinforcement according to claim 5, wherein the dipped and heat-set polyethylene terephthalete cord is used as carcass ply in pneumatic radial tires as dipped and heat-set cord.
